(19) United States
(12) Patent Application Publication
(10) Pub. No.: US 2013/0155035 A1
(43) Pub. Date: Jun. 20, 2013

(54) METHOD FOR DRIVING PIXEL CIRCUITS

(71) Applicants: Szu-Chieh CHEN, Hsin-Chu (TW); Yu-Hsin TING, Hsin-Chu (TW); Chung-Lung LI, Hsin-Chu (TW); Chen-Ming CHEN, Hsin-Chu (TW); I-Fang CHEN, Hsin-Chu (TW); Yun-Chung LIN, Hsin-Chu (TW); Da-Yei FAN, Hsin-Chu (TW); Yi-Xuan HUNG, Hsin-Chu (TW); Chun-Yu HUANG, Hsin-Chu (TW)

(72) Inventors: Szu-Chieh CHEN, Hsin-Chu (TW); Yu-Hsin TING, Hsin-Chu (TW); Chung-Lung LI, Hsin-Chu (TW); Chen-Ming CHEN, Hsin-Chu (TW); I-Fang CHEN, Hsin-Chu (TW); Yun-Chung LIN, Hsin-Chu (TW); Da-Yei FAN, Hsin-Chu (TW); Yi-Xuan HUNG, Hsin-Chu (TW); Chun-Yu HUANG, Hsin-Chu (TW)

(73) Assignee: AU OPTRONICS CORP., Hsin-Chu (TW)

(21) Appl. No.: 13/609,310

(22) Filed: Sep. 11, 2012

(30) Foreign Application Priority Data
Dec. 16, 2011 (TW) 100146938

(51) Int. Cl. G06F 3/038

(52) U.S. Cl. 345/204

(57) ABSTRACT

A method for driving a pixel circuit, which is adapted to drive a first pixel circuit coupled to a first gate line and a second pixel circuit coupled to a second gate line, is disclosed. The first pixel circuit receives display data before the second pixel circuit does. The method provides only one first enable pulse to the first gate line in a frame, and provides a second enable pulse and a third enable pulse to the second gate line in the same frame. The starting time of the second enable pulse is in an enabled time period of the first enable pulse, and the enabled time period of the third enable pulse is after the enabled time periods of the first and second enable pulses.

### TECHNICAL FIELD

The present invention relates to a method for driving pixel circuits, and more particularly to a driving for pixel circuits having driving times which are not totally the same.

### BACKGROUND

Currently, the pixel circuits usually used in the flat plane display all employ capacitance to store different data voltage, so as to induce different optical brightness performance. However, following increasing of resolution, each pixel is affected by each other more obviously than before through capacitance couple effect because of the variation of data voltage.

FIG. 1 is a schematic diagram of arrangement manner of pixel circuits for an ordinary flat plane display. Referring to FIG. 1, pixel circuits R₁ and G₁ are both electrically coupled to data line D₁, so that the pixel circuit R₁ is controlled by gate line S₁ to receive a display data from the data line D₁, and the pixel circuit G₁ is controlled by gate line S₂ to receive the display data from the data line D₁. Similarly, pixel circuits B₁ and R₂, pixel circuits G₂ and B₂, pixel circuits G₃ and B₃, pixel circuits R₃ and G₄, and pixel circuits B₄ and R₄ etc., are electrically coupled to the same data line (D₁, D₂ or D₃) with one and another, and two pixel circuits electrically coupled to the same data line are controlled by different gate lines to receive the display data from the same data line.

Generally, the sequence of scanning gate line is top down. In another word, the gate line S₁ is first scanned, and then the gate lines S₂, S₃ and S₄ are scanned sequentially. Therefore, in the beginning, the pixel circuits R₁, B₁ and G₂ receive the display data, and then the pixel circuits G₁, R₂ and B₂ receive the display data, and next the pixel circuits G₃, R₃ and B₄ receive the display data. Finally, the pixel circuits B₃, G₄ and R₄ receive the display data. For the pixel circuits G₁, G₂, G₃ and G₄, which receive the display data of green, the pixel circuits G₂ and G₃ are affected to change stored display data because of the capacitance effect as the pixel circuits B₂ and B₃ being charged, but the stored display data of the pixel circuits G₁ and G₄ are not affected by the capacitance effect. Such that, the overall screen has the brightness non-uniform phenomenon.

### SUMMARY

The present invention provides a method for driving pixel circuits for reducing the brightness non-uniform phenomenon caused by charge coupled effect.

The present invention provides a method for driving a pixel circuits adapted to drive a first pixel circuit coupled to a first gate line and a second pixel circuit coupled to a second gate line, is disclosed. The first pixel circuit receives display data before the second pixel circuit does. The method provides only one first enable pulse to the first gate line in a frame, and provides a second enable pulse and a third enable pulse to the second gate line in the same frame. The starting time of the second enable pulse is in an enabled time period of the first enable pulse, and an enabled time period of the third enable pulse is after the enabled time periods of the first and second enable pulses.

The present invention employs the method of portion of gate lines having unequal driving time. Therefore, when a display data would be following written in the pre-charged portion of the pixel circuits, the voltage variation thereof would be reduced, so as to reduce the charge couple effect between said portion of the pixel circuits and the rest of pixel circuits for improving brightness uniform ability as overall displayed.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of arrangement of pixel circuits for an ordinary flat plane display.

FIG. 2A is a flow chart according to an embodiment of the present invention.

FIG. 2B is a timing diagram of the first enabling pulse and the second enabling pulse according to an embodiment of the present invention.

FIG. 3 is a timing diagram of driving waveform generated by a method for driving pixel circuits according to an embodiment.

FIG. 4 is a schematic diagram of an arrangement structure of pixel circuits of half source driving (HSD) display panel.

FIG. 5 is a timing diagram of a driving waveform generated by a method for driving pixel circuits according to another embodiment.

FIG. 6 is a timing diagram of a driving waveform generated by a method for driving pixel circuits according to one preferred embodiment of the present invention.

FIG. 7A is a schematic diagram of polarity of display data voltage potential in each pixel circuit in a display time of one of frames as the inversion mode of the data polarity being two-dot inversion mode.

FIG. 7B is a schematic diagram of polarity of display data voltage potential in each pixel circuit in a display time of previous frame or next frame of FIG. 7A.

FIG. 8A is a schematic diagram of polarity of display data voltage potential in each pixel circuit in a display time of one of frames as the inversion mode of the data polarity being row inversion mode.

FIG. 8B is a schematic diagram of polarity of display data voltage potential in each pixel circuit in a display time of previous frame or next frame of FIG. 8A.

FIG. 9A is a schematic diagram of polarity of display data voltage potential in each pixel circuit in a display time of one of frames as the inversion mode of the data polarity being another two-dot inversion mode.

FIG. 9B is a schematic diagram of polarity of display data voltage potential in each pixel circuit in a display time of previous frame or next frame of FIG. 9A.

FIG. 10A is a schematic diagram of polarity of display data voltage potential in each pixel circuit in a display time of one of frames as the inversion mode of the data polarity being dot inversion mode.

FIG. 10B is a schematic diagram of polarity of display data voltage potential in each pixel circuit in a display time of previous frame or next frame of FIG. 10A.

FIG. 11A is a schematic diagram of polarity of display data voltage potential in each pixel circuit in a display time of one of frames as the inversion mode of the data polarity being column inversion mode.

FIG. 11B is a schematic diagram of polarity of display data voltage potential in each pixel circuit in a display time of previous frame or next frame of FIG. 11A.

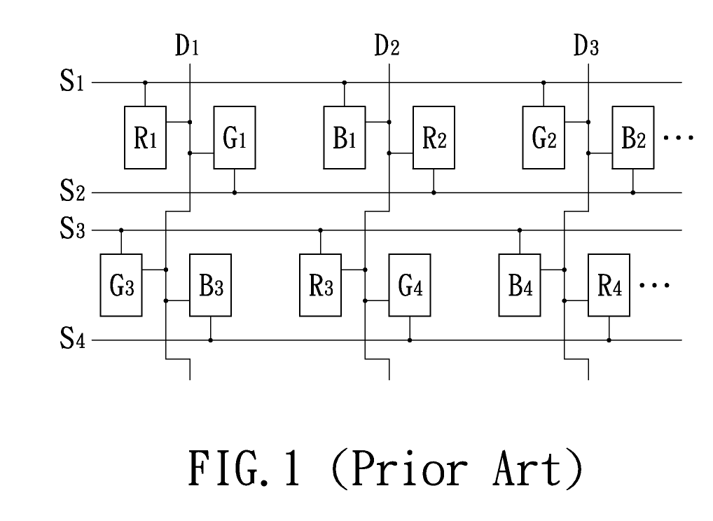

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

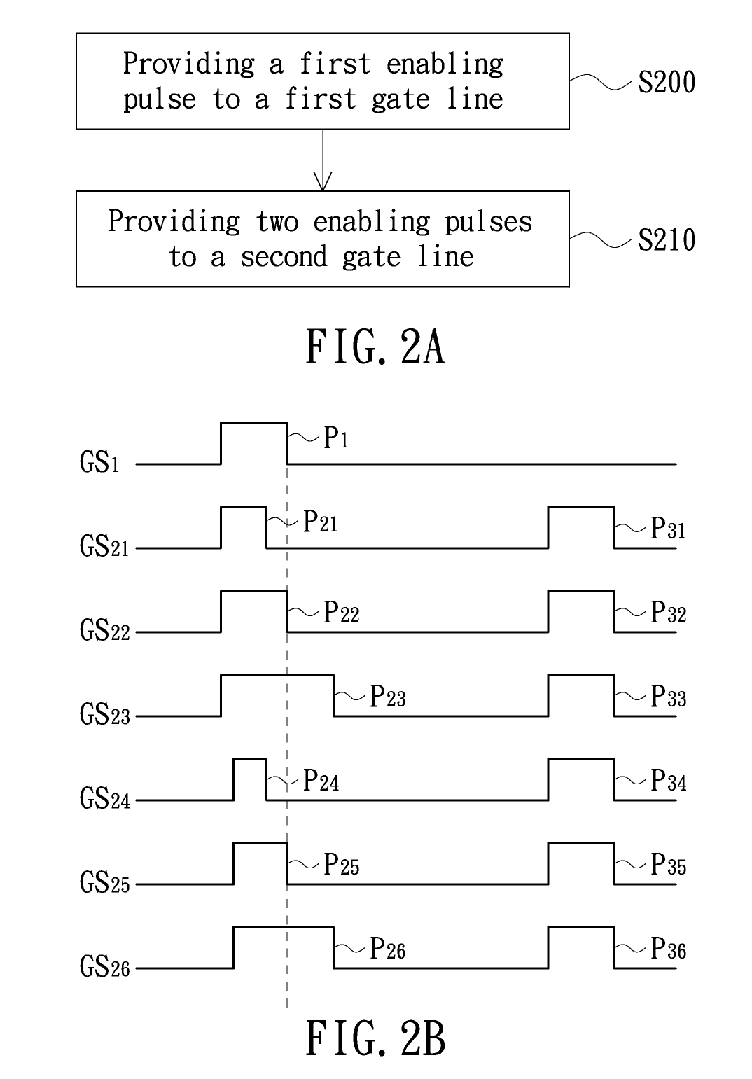

FIG. 2A is a flow chart according to an embodiment of the present invention. Referring to FIG. 2A, the method described in the embodiment is adapted to drive a first and a second pixel circuits, electrically coupled to a first gate line and a second gate line respectively, wherein the first pixel receives a display data for displaying earlier then the second pixel circuit. The embodiment only provides one enabling pulse (hereafter, first enabling pulse) to a first gate line in one frame (step S200), and provides two enabling pulses (hereafter, second enabling pulse and third enabling pulse) to a second gate line in the same frame (step S210).

In this embodiment, an enabling start-up time is in an enabling time period of the first enabling pulse, and an enabling time period of the third enabling pulse is behind the enabling time periods of the first and the second enabling pulses. FIG. 2B is a timing diagram of the first enabling pulse and the second enabling pulse according to an embodiment of the present invention. Referring to FIG. 2B, signal GS₁ means a signal for providing to the first gate line in a time of one frame, and signals GS₂₁˜GS₂₆ show a plurality of types of possible pattern for signals for providing to the second gate line in the same frame. As shown in FIG. 2B, among the signals GS₂₁˜GS₂₃, the second enabling pulses P₂₁˜P₂₂ and P₂₃ as well as only one pulse for providing the first gate line (i.e., the first enabling pulse) P₁ are enabled in the same time; among the signals GS₂₄˜GS₂₆, the second enabling pulses P₂₄, P₂₅ and P₂₆ are enabled before end of the first enabling pulse P₁.

No matter of the enabling start-up time of the second enabling pulse P₂₁˜P₂₆, an end-off time thereof has many different types of design manners. For example, the second enabling pulse can be ended earlier than the first enabling pulse, such as the second enabling pulses P₂₁ and P₂₄ among the signals GS₂₁ and GS₂₄; or the second enabling pulse and the first enabling pulse are ended at the same time, such as the second enabling pulses P₂₂ and P₂₅ among the signals GS₂₂ and GS₂₅; or the second enabling pulse can be ended later then the first enabling pulse, such as the second enabling pulses P₂₃ and P₂₆ among the signals GS₂₃ and GS₂₆.

Simply speaking, since an object for employing the second enabling pulse is that the pixel circuits controlled by the second gate line can be pre-charged and the voltage potential variation scale of follow-up receiving the display data can be reduced, the preferred design manner is: employing polarities of the display data received by the first pixel circuits, which is turned on by the first enabling pulse, as well as, the second and the third pixel circuits, which are turned on by the second and the third enabling pulses, are the same, so as to make the enabling start-up time of the second enabling pulse not earlier than the enabling start-up time of the first enabling pulse and the enabling time period of the second enabling pulse and the enabling time period of first enabling pulse have overlap period. Therefore, when the pixel circuits controlled by the first gate line receive the display data, the pixel circuits controlled by the second gate line can be pre-charged by the voltage has the same polarity with the first gate line. Hence, once the second enabling pulse is turned off earlier than the voltage potential of the data line is inversed, the objection of pre-charging can be implemented.

The third enabling pulses P₃₁˜P₃₆ shown in FIG. 2B are provided to the second lines to control the previously pre-charged pixel circuits being able to receive the display data suitably. This design manner can be adjusted following with the different arrangement structures of each pixel, and redundancy descriptions can be omitted.

Following paragraphs will describe the real arrangement structure of the pixels and combination design of above method.

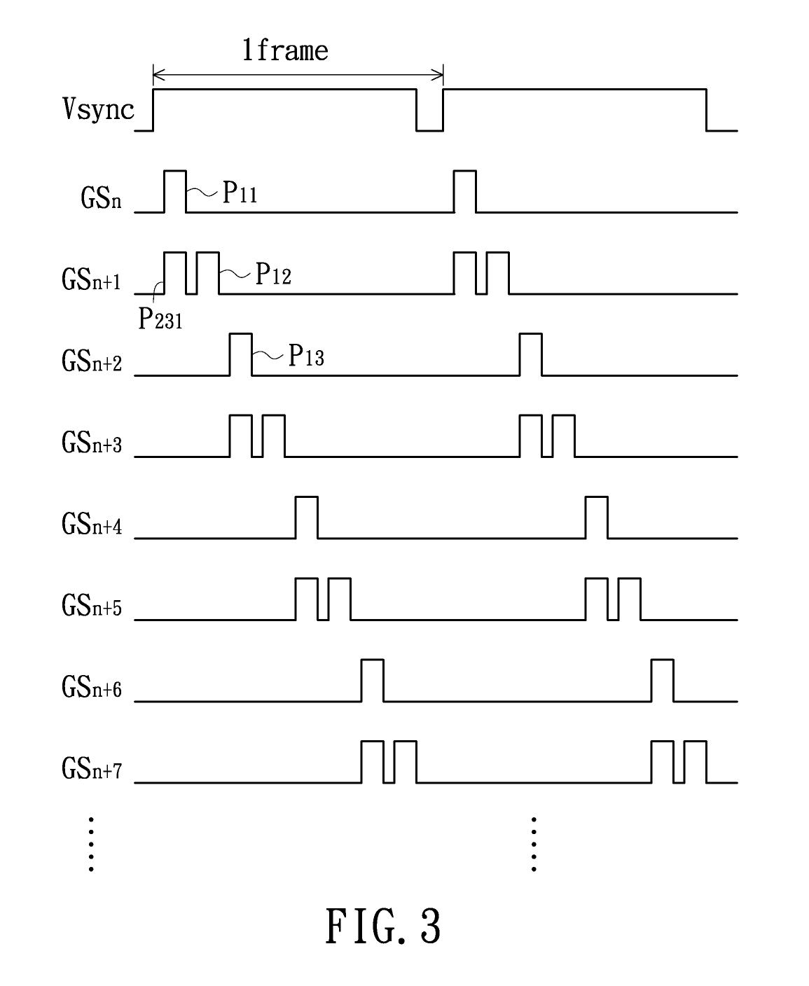

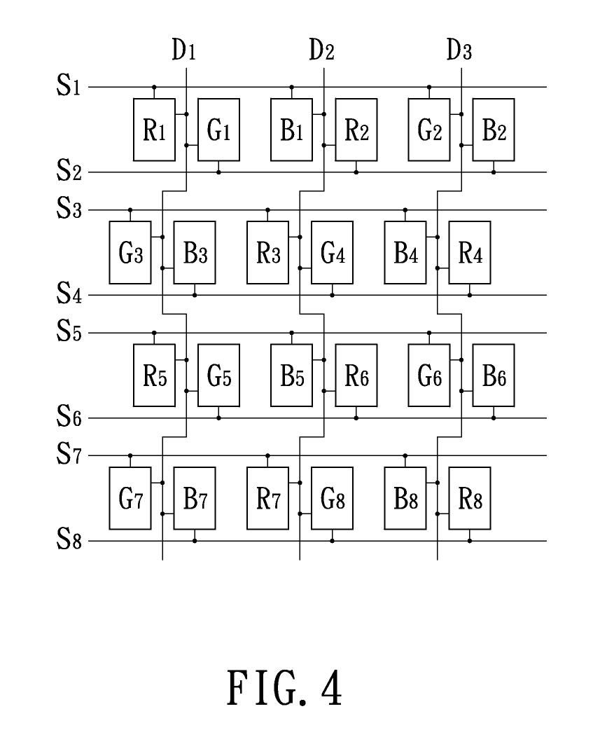

FIG. 3 is a timing diagram of driving waveform generated by the method for driving the pixel circuits according to an embodiment. Referring to FIG. 3, the method can be employed in different types of arrangement structure of the pixel circuits. For convenience explaining, the following description refers to an arrangement structure of a half source driving (HSD) display panel shown in the FIG. 4. It should be noted, the relative position between the gate lines S₁ and S₂, or gate lines S₂ and S₃ is defined adjacency. In another word, if no other gate line is configured between the above two gate lines, the above gate lines are defined adjacent gate lines, even a pixel circuit is configured between the above two gate lines. Similarly, such as the substantial relative relationship between the pixel circuits R₁ and G₁, or pixel circuits G₁ and B₁ is defined adjacency in this patent.

Referring to FIGS. 3 and 4 together, the signals GSₙ˜GSₙ₊₇ are the signals provided a plurality of gate lines which are driven sequentially. For example, the signal GSₙ is provided to the gate line S₁, the signal GSₙ₊₁ is provided to the gate line S₂, the signal GSₙ₊₂ is provided to the gate line S₃, the signal GSₙ₊₃ is provided to the gate line S₄, the signal GSₙ₊₄ is provided to the gate line S₅, the signal GSₙ₊₅ is provided to the gate line S₆, the signal GSₙ₊₆ is provided to the gate line S₇, and the signal GSₙ₊₇ is provided to the gate line S₈. It should be noted that the driving sequence is sequence of driving time, and not limited on sequence of physical arrangement.

Referring to FIG. 3, in this embodiment, the signals GSₙ, GSₙ₊₂, GSₙ₊₄ and GSₙ₊₆ are the same with said signal provided to the first gate line, and the signals GSₙ₊₁, GSₙ₊₃, GSₙ₊₅ and GSₙ₊₇ are the same with said signal provided to the second gate line. Where just states the timing relationship between the signals GSₙ and GSₙ₊₁, the rest of timing relationships, such as the timing relationship between the signals GSₙ₊₂ and GSₙ₊₃, timing relationship between the signals GSₙ₊₄ and GSₙ₊₅ and timing relationship between the signals GSₙ₊₆ and GSₙ₊₇ are similar with the relationship of the signals GSₙ and GSₙ₊₁, so as to omit redundancy descriptions.

In one period of vertical synchronous signal Vsync, which is equal in the time of one frame, the signal GSₙ is only provide one enabling pulse P₁₁(equal in the first enabling pulse) to the gate line S₁, the signal GSₙ₊₁ provides the enabling pulse P₂₃₁(equal in the second enabling pulse) and enabling pulse P₁₂(equal in the third enabling pulse) to the gate line S₂. Wherein, the timing corresponding relationship between the enabling pulse P₁₁ and P₂₃₁ can be any of the corresponding relationship between enabling pulse P₁ and enabling P₂₁˜P₂₆ shown in FIG. 2B.

Referring to FIG.4 together, when the enabling pulse P₁₁ is provided to the gate line S₁, the pixel circuits R₁, B₁ and G₂ turn on for receiving the display data transmitted on the data lines D₁, D₂ and D₃. Since the enabling time periods of enabling pulse P₂₃₁ and P₁₁ have overlap portion, the pixel circuits G₁, R₂ and B₂ also turn on for receiving the display data transmitted on the data line D₁, D₂ and D₃ as the pixel circuits R₁, B₁ and G₂ receiving the display data. The objection for the pixel circuits G₁, R₂ and B₂ receiving the display data isn't to display received display data, but to pre-charge the pixel circuits G₁, R₂ and B₂. Therefore, once the enabling pulse P₁₂ is provided to the gate line S₂, the voltage potential of the pixel circuits G₁, R₂ and B₂ would vary into the voltage potential of the display data transmitted on the data lines D₁, D₂ and D₃ from the basic voltage potential caused by pre-charging, after the enabling pulse P₁₁ and P₂₃₁ aren't enabled.

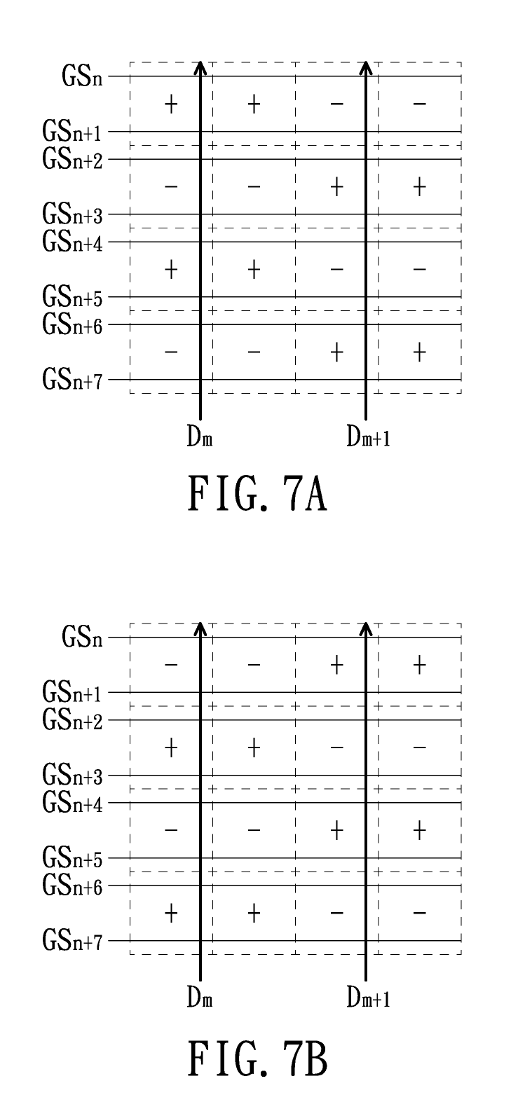

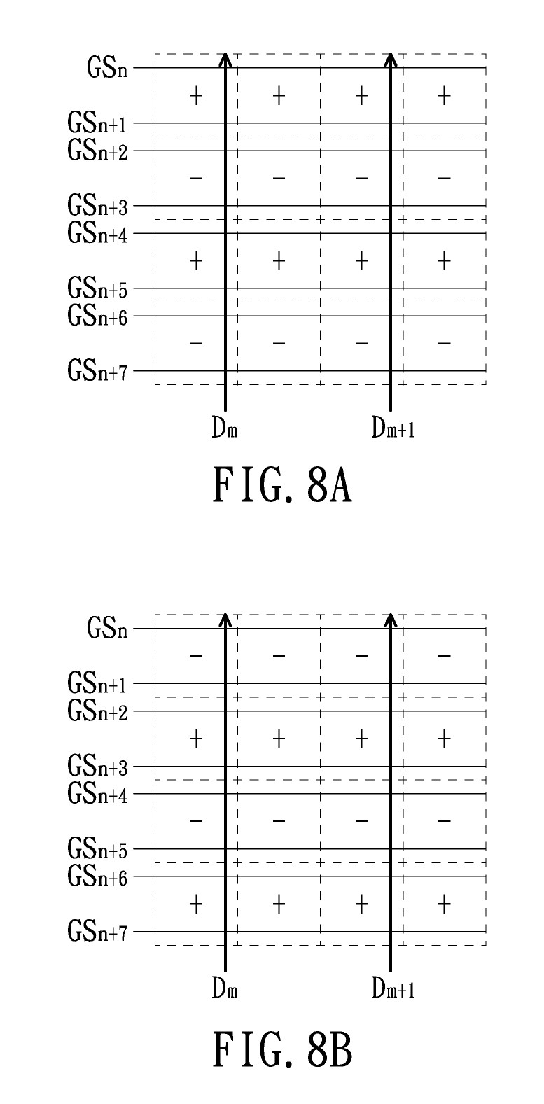

In order to reduce the capacitance effect, a polarity of the display data employed for pre-charging should be the same with the display data employed for displaying latter. In another word, when the waveform shown in FIG. 3 cooperates with the arrangement structure of pixel circuits shown in FIG. 4 and combines the relationship between the above assumed signals GSₙ˜GSₙ₊₇ and gate lines S₁˜S₈, a polarity inversion modes of the adjacent two pixel circuits coupled to the same data line are the same. In other word, the two-dot inversion shown in FIGS. 7A and 7B and the row inversion shown in FIGS. 8A and 8B are suitable polarity inversion modes for this condition. FIGS. 7A and 7B show the polarity of display data voltage potential in each adjacent pixel circuit, wherein “+” indicates the display data being positive voltage potential, and “−” indicates the display data being negative voltage potential. Similarly, FIGS. 8A and 8B show the polarity of voltage potential of display data in each adjacent two pixel circuits, too. In addition, Dₘ and Dₘ₊₁ are two adjacent data lines in FIGS. 7A, 7B, 8A and 8B, wherein the arrow direction indicates the display data transmitted direction not scanning sequence.

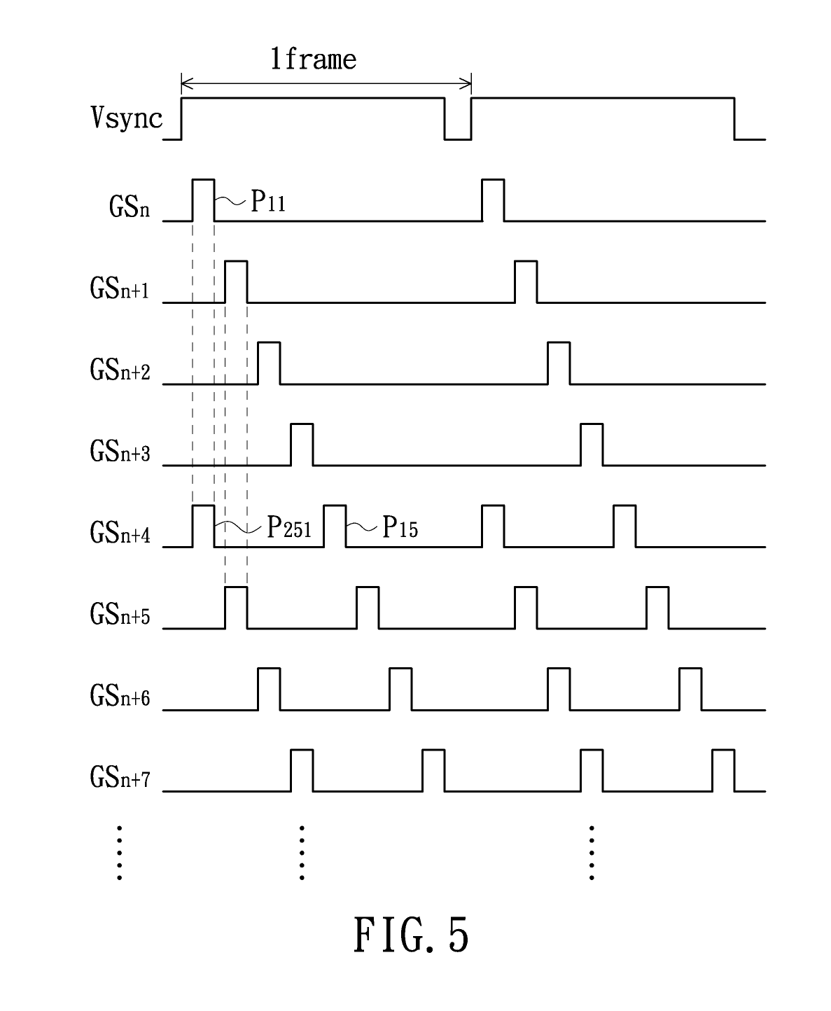

FIG. 5 is a timing diagram of a driving waveform generated by a method for driving pixel circuits according to another embodiment. Referring to FIG. 5, in this embodiment, signals GSₙ, GSₙ₊₁, GSₙ₊₂ and GSₙ₊₃ are equal in said signals provided to the first gate line, and signals GSₙ₊₄, GSₙ₊₅, GSₙ₊₆ and GSₙ₊₇ are equal in said signals provided to the second gate line. Where just states the timing relationship between signals GSₙ and GSₙ₊₄, other timing relationship, such as timing relationship between signals GSₙ₊₁ and GSₙ₊₅, timing relationship between signals GSₙ₊₂ and GSₙ₊₆ and timing relationship between signals GSₙ₊₃ and GSₙ₊₇ are similar with the timing relationship of signals GSₙ and GSₙ₊₄, so as to omit redundancy description.

In time of one period of a vertical synchronous signal Vsync, the signal GSₙ just provides only one enabling pulse P₁₁ (equal in the first enabling pulse) to the gate line S₁, and signal GSₙ₊₄ provides a enabling pulse P₂₅₁ (equal in the second enabling pulse) and enabling pulse P₁₅ (equal in the third enabling pulse) to the gate line S₅. Wherein, a corresponding relationship between of the enabling pulse P₁₁ and P₂₅₁ can be the corresponding relationship between the enabling pulse P₁ shown in FIG. 2B and any of the enabling pulses P₂₁˜P₂₆.

Referring to FIG. 4 together, when the enabling pulse P₁₁ is provided to the gate line S₁, the pixel circuits R₁, B₁ and G₂ turn on for receiving the display data transmitted on the data lines D₁, D₂ and D₃ respectively. Since an enabling time period of enabling pulse P₂₅₁ and P₁₁ have overlap portion, the pixel circuits R₅, B₅ and G₅ also turn on for receiving the display data transmitted on the data line D₁, D₂ and D₃ as the pixel circuits R₁, B₁ and G₂ receiving the display data. The pixel circuits G₁, R₂ and B₂ receiving the display data operation is also to pre-charge the pixel circuits R₅, B₅ and G₅. Therefore, once the enabling pulse P₁₅ is provided to the gate line S₅, the voltage potential of the pixel circuits R₅, B₅ and G₅ would vary into the voltage potential of the display data transmitted on the data lines D₁, D₂ and D₃ from the basic voltage potential caused by pre-charging, after the enabling pulse P₁₁ and P₂₅₁ aren't enabled.

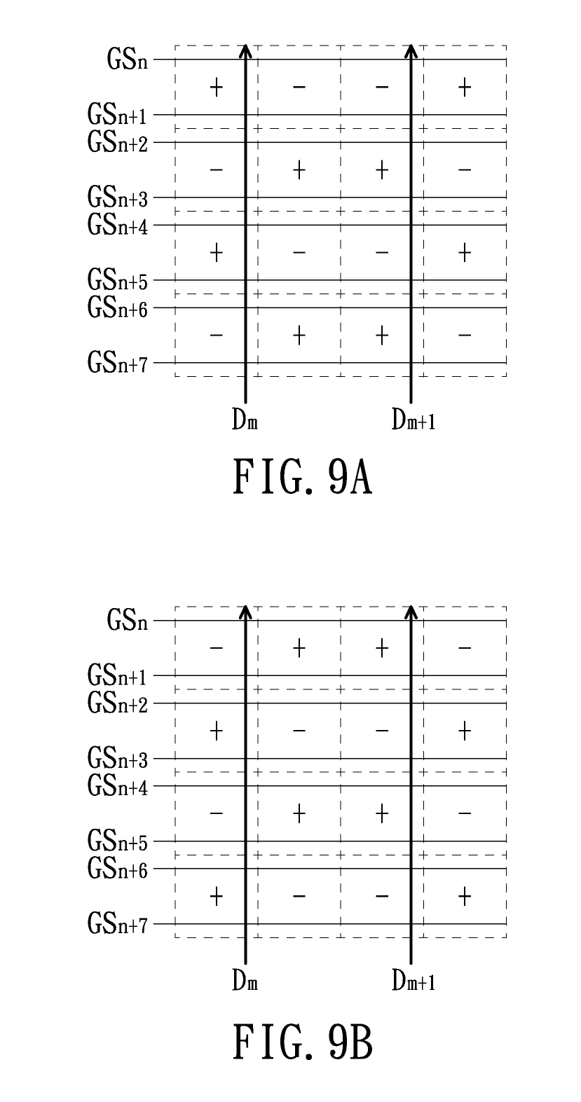

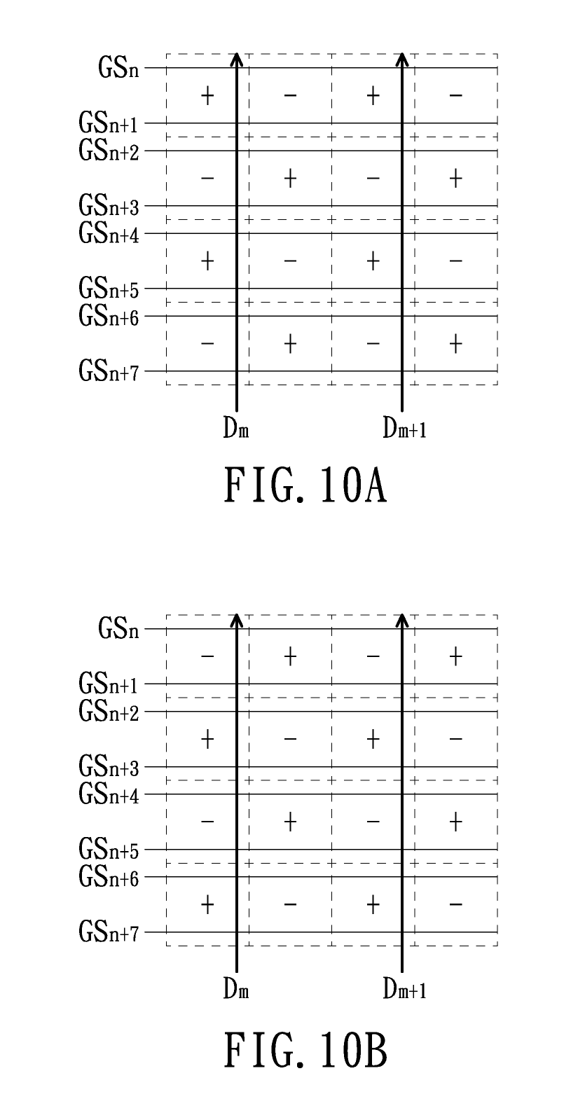

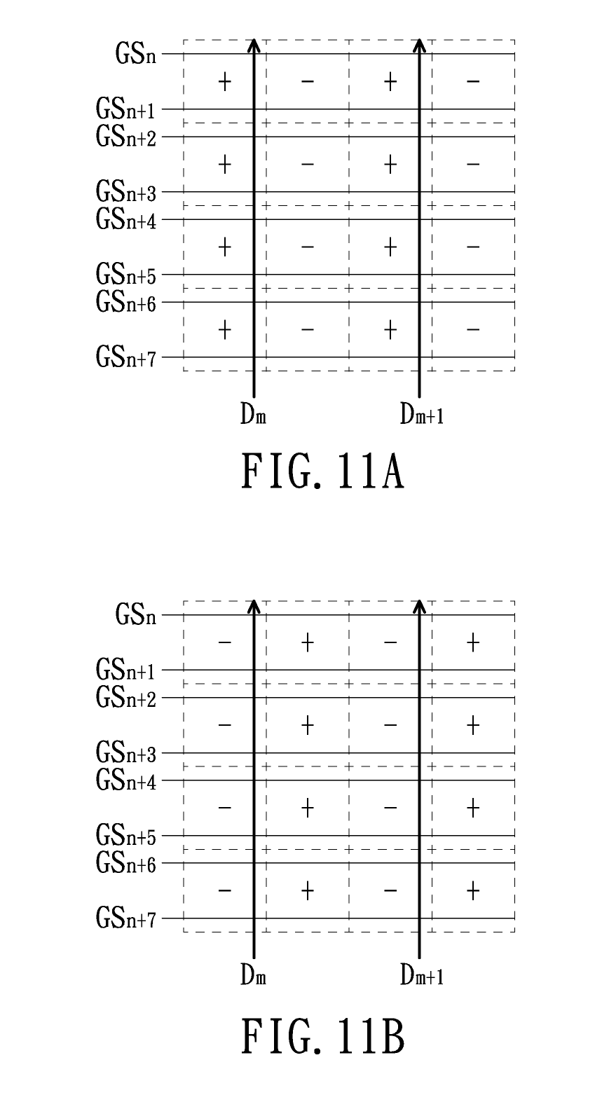

In order to reduce the capacitance effect, a polarity of the display data employed for pre-charging should be the same with the display data employed for real displaying latter. In another word, when the waveform shown in FIG. 5 cooperates with the arrangement structure of pixel circuits shown in FIG. 4 and combines the relationship between the above assumed signals GSₙ˜GSₙ₊₇ and gate lines S₁˜S₈, a polarity inversion modes of the adjacent two pixel circuits coupled to the same data line and disposed at the same side are specific designed, such like said two-dot inversion shown in FIGS. 7A and 7B and row inversion shown in FIGS. 8A and 8B are both the polarity inversion modes suitable for this condition. In addition, another two-dot inversion shown in FIGS. 9A and 9B, dot inversion shown in FIGS. 10A and 10B, and column inversion shown in FIG. 11A and 11B are also all suitable polarity inversion modes for this condition. Where FIGS. 9A and 9B, FIGS. 10A and 10B, and FIGS. 11A and 11B show the polarity of display data voltage potential in each adjacent pixel circuit, wherein “+” indicates the display data being positive voltage potential, and “−” indicates the display data being negative voltage potential. Similarly, Dₘ and Dₘ₊₁ are two adjacent data lines in FIGS. 9A and 9B, FIGS. 10A and 10B, and FIGS. 11A and 11B, wherein the arrow direction indicates the display data transmitted direction not scanning sequence.

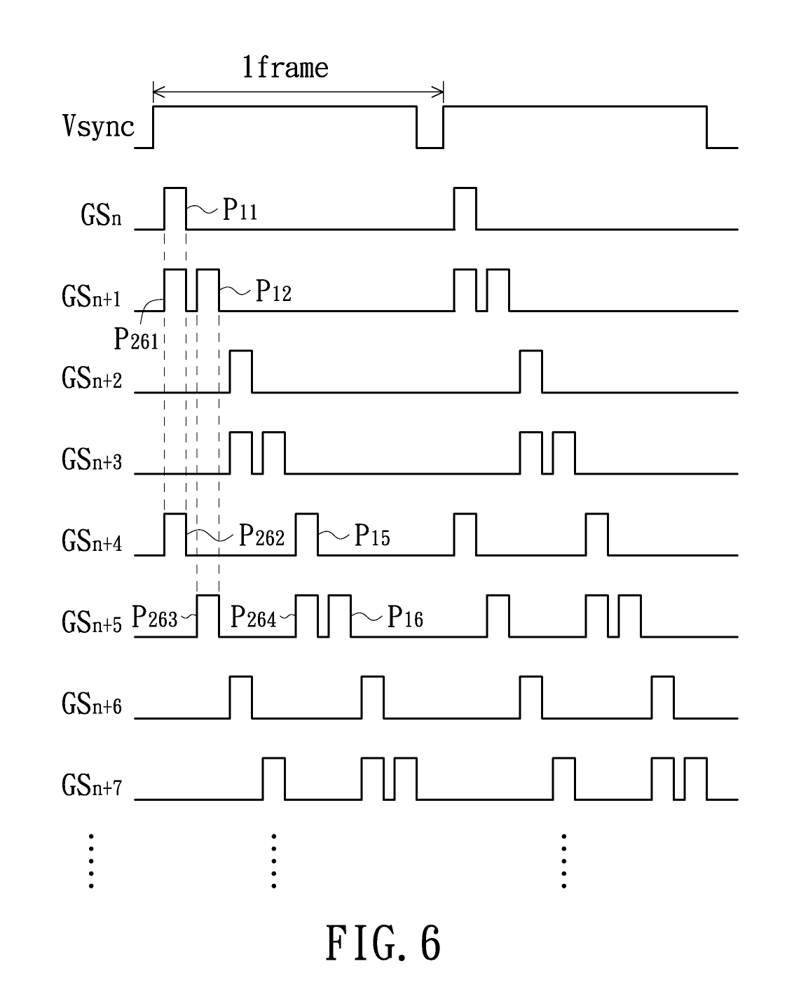

FIG. 6 is a timing diagram of a driving waveform generated by a method for driving pixel circuits according to one preferred embodiment of the present invention. Similarly, the following description is cooperated with the arrangement structure of pixel circuits shown in FIG. 4, and the relationships between each signal and gate line are the same with the corresponding relationships of the embodiment of FIGS. 3 and 4.

Simply speaking, the driving waveform is a result by combining the driving waveform shown in FIGS. 4 and 5. We can see different design aspect, which causes the same driving result, form different viewpoint.

From the first viewpoint of the embodiment, if the signals GSₙ and GSₙ₊₁ are said signals provided to first gate line and the second gate line respectively and the signals GSₙ₊₄ and GSₙ₊₅ are the signals provided another tow gate lines (hereafter, third gate line and fourth gate line), the waveform matches the following description:

Only one first enabling pulse is provided to the first gate line, where is gate line S₁, in one frame, and the second and third enabling pulses to the second gate lines, where is gate line S₂, in the same frame. In addition, two enabling pulses (hereafter, four and fifth enabling pulses) are further provided to a third gate line, where is gate line S₅, and three enabling pulses (hereafter, sixth, seventh, and eighth enabling pulses) to a fourth gate line, where is gate line S₆.

In this viewpoint, in one period of the vertical synchronous signal Vsnyc, the signal GSₙ only provides one enabling pulse P₁₁ (equal in the first enabling pulse) to the gate line S₁, and the signals GSₙ₊₁ provides the enabling pulse P₂₆₁ (equal in the second enabling pulse) and the enabling pulse P₁₂ (equal in the third enabling pulse) to gate line S₂. In addition, signal GSₙ₊₄ provides the enabling pulse P₂₆₂ (equal in the fourth enabling pulse) and the enabling pulse P₁₅ (equal in the fifth enabling pulse) to gate line S₅, and signal GSₙ₊₅ provides the enabling pulse P₂₆₃ (equal in sixth enabling pulse), the enabling pulse P₂₆₄ (equal in seventh enabling pulse) and the enabling pulse P₁₆ (equal in the eighth enabling pulse) to gate line S₆.

The corresponding relationship of timing between the enabling pulse P₁₁ and the enabling pulse P₂₆₁ can be corresponding relationship between the enabling pulse P₁ and any of the enabling pulses P₂₁˜P₂₆ shown in the FIG. 2B. Additionally, an enabling start-up time of the enabling pulse P₂₆₂ is in an enabling time period of the enabling pulse P₁, an enabling time period of the enabling pulse P₁₅ is behind the enabling time period of the enabling pulse P₁₂, an enabling start-up time of the enabling pulse P₂₆₃ is in the enabling time period of the enabling pulse P₁₂, an enabling start-up time of the enabling pulse P₂₆₄ is in the enabling time period of the enabling pulse P₁₅, and an enabling time period of the enabling pulse P₁₆ is behind the enabling time period of the enabling pulse P₁₅.

The relationships of each enabling pulse in another set of signals GSₙ₊₂, GSₙ₊₃, GSₙ₊₆, and GSₙ₊₇ are the same with the relationships of the enabling pulses in above signals GSₙ, GSₙ₊₁, GSₙ₊₄, and GSₙ₊₅, so as to omit the redundancy description.

From the second viewpoint of the embodiment, if the signals GSₙ and GSₙ₊₄ are said signals provided to the first gate line and the second gate line, and the signals GSₙ₊₁ and GSₙ₊₅ are the signals provided to another gate line (hereafter, third gate line and fourth gate line), this waveform also matches the related description in the first viewpoint:

Only one first enabling pulse is provided to the first gate line, where is gate line S₁, in one frame, and the second and third enabling pulses to the second gate lines, where is gate line S₅, in the same frame. In addition, two enabling pulses (hereafter, four and fifth enabling pulses) are further provided to a third gate line, where is gate line S₂, and three enabling pulses (hereafter, sixth, seventh, and eighth enabling pulses) to a fourth gate line, where is gate line S₆.

In this viewpoint, in one period of the vertical synchronous signal Vsnyc, the signal GSₙ only provides one enabling pulse P₁₁ (equal in the first enabling pulse) to the gate line S₁, and the signals GSₙ₊₄ provides the enabling pulse P₂₆₂ (equal in the second enabling pulse) and the enabling pulse P₁₅ (equal in the third enabling pulse) to gate line S₅. In addition, signal GSₙ₊₁ provides the enabling pulse P₂₆₁ (equal in the fourth enabling pulse) and the enabling pulse P₁₂ (equal in the fifth enabling pulse) to gate line S₂, and signal GSₙ₊₅ provides the enabling pulse P₂₆₃ (equal in sixth enabling pulse), the enabling pulse P₂₆₄ (equal in seventh enabling pulse) and the enabling pulse P₁₆ (equal in the eighth enabling pulse) to gate line S₆.

The corresponding relationship of timing between the enabling pulse P₁₁ and the enabling pulse P₂₆₂ can be corresponding relationship between the enabling pulse P₁ and any of the enabling pulses P₂₁˜P₂₆ shown in the FIG. 2B. Additionally, an enabling start-up time of the enabling pulse P₂₆₁ is in a enabling time period of the enabling pulse P₁, an enabling time period of the enabling pulse P₁₂ is behind the enabling time period of the enabling pulse P₁₁, an enabling start-up time of the enabling pulse P₂₆₃ is in the enabling time period of the enabling pulse P₁₂, an enabling start-up time of the enabling pulse P₂₆₄ is in the enabling time period of the enabling pulse P₁₅, and an enabling time period of the enabling pulse P₁₆ is behind the enabling time period of the enabling pulse P₁₅.

The relationships of each enabling pulse in another set of signals GSₙ₊₂, GSₙ₊₆, GSₙ₊₃, and GSₙ₊₇ are the same with the relationships of the enabling pulses in above signals GSₙ, GSₙ₊₄, GSₙ₊₁, ^{and} GSₙ₊₅, so as to omit the redundancy description.

The above two viewpoint related to FIG. 6 explain the focus of the present invention is to control the amount of enabling pulses according to the scanning sequence without limiting the real disposed sequence of scan lines. In other word, the real line disposed manner can be adjusted randomly just performing the corresponding driving according to above scanning sequence. For example, the first gate line in the first viewpoint can be configured adjacent to the second gate line, and the third gate line can be configured adjacent to the fourth gate line; but in the second viewpoint, the first gate line is configured adjacent to the third gate line, and the second gate line is configured adjacent to the fourth gate line.

However, no matter of viewpoints, above third pixel circuit controlled by the third gate line should receive the display data for displaying earlier than the fourth pixel circuit controlled by the fourth gate line.

Since the waveform in the embodiment shown in FIG. 6 can be seen the combination of the embodiments shown in FIGS. 3 and 5, the polarity inversion modes of display data among each pixel circuit must satisfy the requests of prior two embodiments. Therefore, under the arrangement structure of pixel circuits as FIG. 4, the two-dot inversion shown in FIGS. 7A and 7B, and the row inversion shown in FIGS. 8A and 8B are suitable data polarity inversion modes.

It should be noted, although the description of the above embodiment only takes one frame as example, in real situation the above method can be executed in each frame not in only one frame of specific time period as limitation. In addition, said first, second, third, and fourth pixel circuits are unnecessary electrically coupled to the same data line, but the polarity of display data on each data line electrically coupled thereof should be the same.

In summary, the present invention employs pre-charging to reduce voltage potential variation scale as data polarity inversed in one time. Since the level of the capacitance effect is determined by the voltage potential variation scale, the above method can be used to reduce brightness non-uniform phenomenon in the screen.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for driving pixel circuits, adapted for driving a first pixel circuit controlled by a first gate line for receiving data and a second pixel circuit controlled by a second gate line for receiving data, wherein the first pixel circuit receives a display data for displaying earlier than the second pixel circuit, and the method comprises:
only providing one first enabling pulse to the first gate line in a frame; and
providing a second enabling pulse and a third enabling pulse to the second gate line in the frame,
wherein an enabling start-up time of the second enabling pulse is in an enabling time period of the first enabling pulse, and an enabling time period of the third enabling pulse is behind the enabling time period of the first enabling pulse and an enabling time period of the second enabling pulse.

2. The method according to claim 1, wherein the first gate line is configured adjacent to the second gate line.

3. The method according to claim 2, wherein the data polarity variations of the first pixel circuit and the second pixel circuit are matched to two-dot inversion or row inversion operation mode.

4. The method according to claim 1, wherein after providing the first enabling pulse to the first gate line, other three gate lines are enabled before providing the third enabling pulse to the second gate line.

5. The method according to claim 4, wherein the data polarity variations of the first pixel circuit and the second pixel circuit are matched to one of dot inversion, two-dot inversion, column inversion and row inversion operation modes.

6. The method according to claim 1, further employing a third gate line to control a third pixel circuit for receiving data and employing a fourth gate line to control a fourth pixel circuit for receiving data, wherein the third pixel circuit receives the display data for displaying earlier than the fourth pixel circuit, and the method further comprises:
providing a fourth enabling pulse and a fifth enabling pulse to the third gate line in the frame; and
providing a sixth enabling pulse, a seventh enabling pulse and an eighth enabling pulse to the fourth gate line in the frame,
wherein an enabling start-up time of the fourth enabling pulse is in the enabling time period of the first enabling pulse, an enabling time period of the fifth enabling pulse is behind the enabling time period of the third enabling pulse, an enabling start-up time of the sixth enabling pulse is in the enabling time period of the third enabling pulse, an enabling start-up time of the seventh enabling pulse is in the enabling time period of the fifth enabling pulse, and an enabling time period of the eighth enabling pulse is behind the enabling time period of the fifth enabling pulse.

7. The method according to claim 6, wherein the first gate line is configured adjacent to the second gate line.

8. The method according to claim 6, wherein the third gate line is disposed adjacent to the fourth gate line.

9. The method according to claim 6, wherein the data polarity variations of the first, the second, the third and the fourth pixel circuits are matched to one of two-dot inversion and row inversion operation modes.

10. The method according to claim 1, further employing a third gate line to control whether or not a third pixel circuit receives data and a fourth gate line to control whether or not a fourth pixel circuit receives data, wherein the third pixel receives the display data for displaying earlier than the fourth pixel circuit, and the method further comprises:
providing a fourth enabling pulse and a fifth enabling pulse to the third gate line in the frame; and
providing a sixth enabling pulse, a seventh pulse and an eighth enabling pulse to the fourth gate line in the frame,
wherein an enabling start-up time of the fourth enabling pulse is in the enabling time period of the first enabling pulse, an enabling time period of the fifth enabling pulse is behind the enabling time period of the first enabling pulse, an enabling start-up time of the sixth enabling pulse is in the enabling time period of the fifth enabling pulse, an enabling start-up time of the seventh enabling pulse is in the enabling time period of the third enabling pulse, and an enabling time period of the eighth enabling pulse is behind the enabling time period of the third enabling pulse.

11. The method according to claim 10, wherein the first gate line is disposed adjacent to the third gate line.

12. The method according to claim 10, wherein the second gate line is disposed adjacent to the fourth gate line.

13. The method according to claim 10, wherein the data polarity variations of the first, the second, the third and the fourth pixel circuits are matched to one of two-dot inversion and row inversion operation modes.

14. The method according to claim 1, further comprising performing the method in a previous frame and a next frame of the frame.
